(19) United States
(12) Patent Application Publication
(10) Pub. No.: US 2008/0151090 A1
(43) Pub. Date: Jun. 26, 2008

(54) Digital Eyepiece Module

(76) Inventor: Kurt Becker, Wettenberg (DE)

Correspondence Address: GRAY ROBINSON, P.A., P.O. Box 2328, FT. LAUDERDALE, FL, 33303-9998, US

(21) Appl. No.: 11/815,877

(22) PCT Filed: Dec. 7, 2005
(86) PCT No.: PCT/EP05/13079

§ 371 Date: Aug. 9, 2007

(30) Foreign Application Priority Data
Feb. 9, 2005 (DE) 10 2005 005 803.5

(51) Int. Cl. H04N 5/335

(52) U.S. Cl. 348/308; 348/E05.091

(57) ABSTRACT

The invention relates to an eyepiece module, for an optical monitoring instrument, comprising at least: a digital image sensor, for the recording of images in an imaging plane of the optical monitoring instrument, a connector, for transmission of the recorded image-related data signals to at least one external device, an integrated image reproduction device, for the display of the images recorded by the image sensor, an electronic controller, for control of the image sensor and for read-out of the image-related data signals from the image sensor into the digital connection and the integrated image reproduction device and a viewing lens, for observation of the image reproduction device by a user.

### CROSS-REFERENCE TO RELATED APPLICATIONS

This application is a U.S. National Phase Entry Under 35 U.S.C. §371 of, and claims priority under 35 U.S.C. §§ 120 and 365 to copending PCT/EP2005/013079, filed Dec. 7, 2005 which designated the U.S. and which claims priority to German Patent Application No. 10 2005 005 803.5, filed Feb. 9, 2005.

### BACKGROUND OF THE INVENTION

1. Field of the Invention

The invention relates to an eyepiece module for an optical observing instrument. The invention likewise relates to a monocular or binocular optical observing instrument.

2. Description of the Related Art

The image information of a telescope when observing objects is often intended to be transmitted elsewhere or made accessible to a number of other persons. For this purpose, it is known to exchange the eyepiece of the telescope for another module, which contains a video camera, for example, which records the image information of the telescope, converts it into a video signal and forwards the latter via a cable or radio link to other devices (TV, monitors, PCs or the like).

The use of such external image reproduction devices has the disadvantage, however, that a telescope itself often no longer affords a sufficient possibility for viewing the image. This is the case particularly when the image reproduction device is situated at a different or concealed position. As a result, it is not possible to take a bearing on the target anew by means of the telescope or else to carry out any correction.

When LCD or TFT monitors are used as external reproduction devices there is the problem, moreover, that not very much can be recognized on the screen in bright sunlight or at an unfavorable viewing angle, which has the effect that even with an observable screen, it is possible to take a bearing on the target by means of the telescope only with difficulty. Furthermore, video cameras often have poor image resolutions and a limited storage capacity.

DE 295 15 553 U1 describes an optical image representing device comprising an optical observing instrument having at least one objective and at least one eyepiece, an image pick-up device having an image pick-up, and a display device connected thereto. The image pick-up device is positioned before the eyepiece instead of the eye.

US 2002/0171924 A1 shows a telescope comprising a camera eyepiece which is connected via link means and which is linked to a computer system via a data cable. In this case, the images recorded by telescope are displayed on a monitor of the computer system.

### SUMMARY OF THE INVENTION

The present invention is based on the object of providing an eyepiece module and an optical observing instrument which avoid the disadvantages of the prior art, in particular enable a positioning of the optical observing instrument for taking a bearing on a target whilst at the same time transmitting image-related data.

The object is achieved according to the invention by means of an eyepiece module in accordance with claim 1 and claim 10. The object is likewise achieved by means of a monocular or binocular optical observing instrument in accordance with claim 14.

By virtue of the fact that the eyepiece module has, in addition to the digital image sensor, an integrated image reproduction device for displaying the images or spatial regions or visual angles recorded by the image sensor, which image reproduction device can be viewed through a viewing optic or an eyepiece, a positioning of the optical observing instrument for taking a bearing on a target whilst at the same time transmitting image-related data signals to the external device (e.g. Notebook, PC, TV or the like) is possible in a simple and advantageous manner. The integrated image reproduction device makes it possible to view the recorded images even in bright sunlight without the external reproduction device having to be available. Orientation of the optical observing instrument or telescope for taking a bearing on a target is thereby ensured.

CCD sensors or CMOS sensors can be used as digital image sensors. Sensors of this type permit the recorded image data to be stored or output on display devices by means of the associated electronic controller or the associated controller components.

It is advantageous if a rewritable memory medium, in particular a flash memory or an exchangeable memory card, in particular for storage and/or further processing of the image data, is provided.

For a sufficient image resolution it is proposed that the image reproduction device is formed as a micro-screen, preferably as an SVGA display, for example on the basis of OLEDs.

The link to the external device can be formed as a radio link (e.g. Bluetooth), as a cable link (e.g. USB) or as an optical link (e.g. Infrared).

Furthermore, the image reproduction device could also be formed as a so-called monocular or binocular head mounted display. This also enables the recorded images to be viewed in bright sunlight. Furthermore, a display having a screen diagonal of greater than 2″ can be provide as the image reproduction device, which display can be used independently of the external device.

Advantageous developments and configurations of the invention emerge from the further subclaims. Advantages with regard to the optical observing instrument emerge analogously and on the basis of the description.

An exemplary embodiment of the invention is illustrated in principle below with reference to the drawing.

### BRIEF DESCRIPTION OF THE DRAWING

FIG. 1 shows a basic illustration of an optical observing instrument according to the invention comprising an eyepiece module according to the invention.

### DETAILED DESCRIPTION

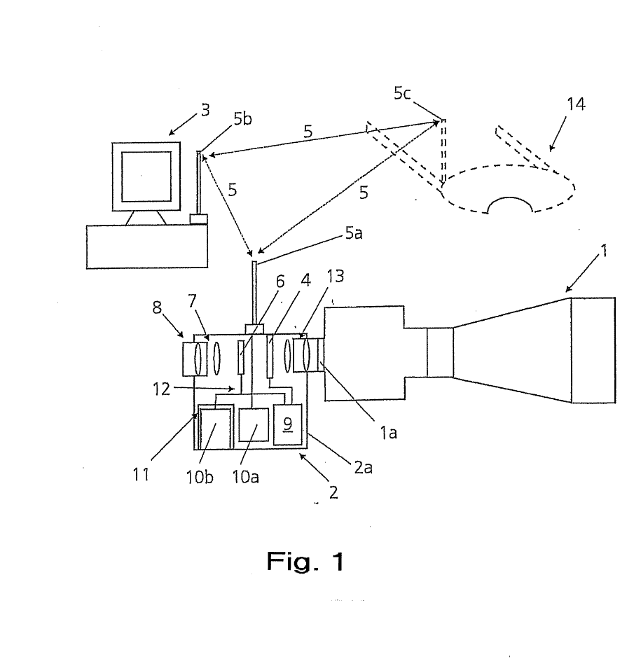

As can be seen from FIG. 1, an optical observing instrument formed as telescope 1 has a digital eyepiece module 2 having a housing 2a for forwarding recorded image-related data signals to a PC 3 as external device. In further exemplary embodiments, notebooks, TVs, palmtops or the like could also be appropriate as external devices. The receiving external devices could have databases for the observed objects or catalogs (e.g. bird determination in ornithological applications).

A bayonet connection 1a of the telescope 1 enables the digital eyepiece module 2 to be coupled or exchanged for a conventional optical viewfinder.

The eyepiece module 2 has a digital CCD image sensor 4 for recording images in an intermediate image plane of the telescope 1. In further exemplary embodiments, this could also be a CMOS image sensor. The CCD image sensor 4 expediently has a resolution of at least 1.0 megapixel. The image-related data signals recorded by the image sensor 4 are communicated to the PC 3 by a radio link 5 with a standardized interface by means of transmitting and receiving parts 5a, 5b provided with antennas. However, cable links (e.g. USB) or optical links (e.g. infrared) are also conceivable for communication purposes.

A micro-screen 6, which in the present case is formed as an SVGA display on the basis of OLEDs, is integrated as image reproduction device into the eyepiece module 2 for displaying the images recorded by the image sensor 4 on the eyepiece module 2 or on the telescope 1. As a result, a positioning of the telescope 1 for taking a bearing on a target whilst at the same time transmitting image-related data signals to the PC 3 is made possible in a simple and advantageous manner.

The integrated micro-screen 6 enables the recorded image-related data signals to be viewed via an eyepiece or viewing optic 7 and an eye-cup 8 (for protection against lateral incidence of light) even in bright sunlight without the PC 3 having to be available for the reproduction. An orientation of the telescope 1 for taking a bearing on a target is thereby ensured.

An electronic controller or a controller component 9 (camera electronics) reads out the image-related data signals from the image sensor 4 and makes it possible to display the recorded images on the micro-screen 6 and/or to the store the image-related data signals for further processing/evaluation on an optional fixedly integrated flash memory 10a or an exchangeable memory card lob formed such that it can be inserted into the eyepiece module 2 through an insertion compartment 11. The CCD image sensor 4, the transmitting part 5a, the micro-screen 6, the flash memory 10a and the exchangeable memory card lob (or an additional interface (not illustrated) to the connection thereof) are linked to the controller component 9 via lines 12 (illustrated in a simplified manner).

In the present exemplary embodiment, an optional, additional, known imaging optic 13 is provided for altered imaging of the intermediate image of the telescope 1 onto the CCD image sensor 4.

Furthermore, the image reproduction device provided could also be a so-called monocular or binocular head mounted display 14 (HMD—indicated by dashed lines in the FIGURE) which communicates with the PC 3 or alternatively with the eyepiece module 2, in particular in wireless fashion by means of a transmitting and receiving part 5c via the link 5.

In other exemplary embodiments, an image processing possibility (e.g. white balance, color filtering, sensitivity adaptation, brightness and/or contrast adaptation) could additionally be integrated into the eyepiece module 2 (not illustrated).

Furthermore, a display having a screen diagonal of greater than 2″ could additionally be provided, which can be used independently of the external device (not illustrated).

Transmission to one or a plurality of further digital eyepieces is also conceivable. A group of observers could therefore each jointly view an object.

Furthermore, the processing of the image-related data signals supplied by the image sensor could take place in the external device only after transmission to the latter.

Furthermore, two viewing optics could also be provided, the optical axes of which are arranged parallel with a variable distance with respect to one another. Two integrated image reproduction devices for displaying the image information recorded by the image sensor are likewise conceivable.

The voltage supply of the eyepiece module 2 is supported by a solar cell in the present case.

Furthermore, a rechargeable battery is provided as voltage source (not specifically illustrated). In further exemplary embodiments, other photoelectric voltage generators could also be provided for voltage supply or for supporting the voltage supply. Exclusive operation with batteries, rechargeable batteries or the like is likewise possible, of course.

What is claimed is:

1. An eyepiece module for an optical observing instrument, comprising:
a digital image sensor for recording images in an intermediate image plane of the optical observing instrument;
a link for forwarding data signals related to said images to at least one external device;
a first integrated image reproduction device for displaying said images recorded by said image sensor;
an electronic controller for driving said image sensor and for reading out said data signals from said image sensor into said link and said integrated image reproduction device; and
a viewing optic for observation of said image reproduction device by a user of the instrument.

2. An eyepiece module as claimed in claim 1, wherein said digital image sensor comprises a CCD sensor or a CMOS sensor.

3. An eyepiece module as claimed in claim 1, further comprising, a rewritable memory medium, said memory medium comprising a flash memory or an exchangeable memory card.

4. An eyepiece module as claimed in claim 1, wherein said image reproduction device comprises a micro-screen.

5. An eyepiece module as claimed in claim 1 further comprising image processing means.

6. An eyepiece module as claimed in claim 1 wherein said link comprises a radio link, a cable link or an optical link.

7. An eyepiece module as claimed in claim 1 further comprising, an additional imaging optic for altered imaging of said intermediate image of said optical observing instrument onto said digital image sensor.

8. An eyepiece module as claimed in claim 1 further comprising, a pair of viewing optics said viewing optics each having a respective optical axis, said optical axes being parallel to one another and spaced a variable distance from one another.

9. An eyepiece module as claimed in claim 1 further comprising, a second integrated image reproduction device, said images being displayed by said second integrated image reproduction device and said first integrated image reproduction device.

10. An eyepiece module for an optical observing instrument, comprising:
a digital image sensor for recording images in an intermediate image plane of the optical observing instrument;
a link for forwarding said data signals to at least one external device and to at least one external image reproduction device for displaying said images recorded by said image sensor, and
an electronic controller for driving said image sensor and for reading out said data signals from said image sensor to said link.

11. An eyepiece module as claimed in claim 10, wherein said external image reproduction device comprises a head mounted display.

12. An eyepiece module as claimed in claim 10, wherein said external image reproduction device comprises a display having a screen diagonal of greater than two inches, which can be used independently of said external device.

13. An eyepiece module as claimed in claim 1 or claim 12, further comprising at least one photoelectric voltage generator for supplying voltage to said eyepiece module or for supporting a supply of voltage to said eyepiece module, said photoelectric voltage generator comprising a solar cell.

14. A monocular or binocular optical observing instrument, in particular, a telescope, said telescope, comprising an eyepiece module as claimed in claim 1 or claim 11, said eyepiece module being an exchangeably mounted eyepiece module.

15. An eyepiece module as claimed in claim 1 wherein said image reproduction device comprises a display having a resolution of SVGA or higher.
